(19) United States
(12) Patent Application Publication
(10) Pub. No.: US 2009/0167525 A1
(43) Pub. Date: Jul. 2, 2009

(54) System, method and apparatus for avoiding loss of portable devices

(76) Inventor: Christopher Gilboy, Freehold, NJ (US)

Correspondence Address: AT & T Legal Department - WS;Attn: Patent Docketing, Room 2A-207, One AT & T Way, Bedminster, NJ, 07921, US

(21) Appl. No.: 12/006,403

(22) Filed: Jan. 2, 2008

(51) Int. Cl. G08B 1/08

(52) U.S. Cl. 340/539.32

(57) ABSTRACT

In a system for monitoring a location of a polled unit, a limitation arises where a polling unit becomes lost or stolen, and a user remains unaware of this loss for an extended time period. In an embodiment of the current invention, a system, apparatus, and method are disclosed for automatically and quickly determining that a polling unit in a polling setup has become lost or stolen. This determination is accomplished by adapting a polled unit to automatically detect an absence of a polling signal within a given time period when a polling signal was expected. After determining that no polling signal was received in the given time period, the polled unit is adapted to perform a function—such as issuing a notification to a user, to a service provider, or to another party.

### BACKGROUND OF THE INVENTION

The present invention relates generally to monitoring the location of items, and more particularly to electronically monitoring the location of portable items.

It is common for a person to carry small objects, for example, keys, wallets, cellular phones, PDAs, purses, jewelry and glasses. Due to their small size, desirability to thieves, and abundance, it is somewhat common for these objects to be misplaced or stolen. Accordingly, the person carrying such portable items may desire to monitor these objects to make sure they do not become lost or stolen. Being able to quickly determine that such an object has become lost or stolen can spell the difference between a minor inconvenience and a financial or emotional catastrophe.

One way to facilitate a monitoring of a portable object is to have a system comprising a controlling unit, (called a polling unit), that sends out a locating signal, (called a polling signal), in order to detect the presence of a tag located with the portable object, (such a tag being called a polled unit). The polling unit has the necessary processor intelligence and hardware to send out a polling signal and determine if a response signal was returned from a polled unit on the monitored object. In the absence of a returned signal, the polling unit may perform an operation—such as notifying the monitored object's owner that the object has fallen out of range of detection. In one monitoring scenario, the polling unit is not portable. In another monitoring scenario, the polling unit is itself a portable object, such as a cellular phone or PDA.

In order to monitor these devices, the polled unit such as a tag is attached to the monitored object. However, such a tag may interfere with the portability and usage of the monitored object. Therefore, it is important for these tags to not only serve their function but also to be of minimal size and weight. Accordingly, tags made with these goals in mind tend to have little or no processor capabilities and very minimal functionality. For example, they can respond to a polling signal, but cannot themselves poll another unit.

Therefore, a problem emerges when valuable portable objects, such as a cellular phone or a PDA are used to monitor the location of other portable items. The system monitors the objects with the polled unit tags; however, the system can not obtain information regarding the location of the polling unit.

This problem has received some attention in the background art. For example, U.S. Pat. No. 7,034,684 discusses a personal-item monitoring-system which monitors not only polled units but also the polling unit. This is accomplished by having another unit in the system with polling means. If a polling unit is determined to be potentially lost or stolen, a phone call to a user-designated, pre-selected, landline phone is made to notify the owned of the loss.

U.S. Pat. No. 7,271,715 also discusses a personal article tracking system and method. This patent discusses linking the polling unit to a radiofrequency identification device (RFID) that is affixed to clothing or jewelry of the owner of the personal article being monitored. Thus, when the polling unit and that particular RFID become separated, it may be assumed that the polling unit has become lost or stolen. The polling unit may then be programmed to contact a third party, such as a third party registry of lost goods to report the loss. The third party can then attempt to contact the owner through pre-established means.

U.S. Pat. No. 6,297,737 discusses an object locating system. It discusses the following: “Tags preferably include a switch that, when actuated, causes the tag to poll the mobile terminal, [i.e. the original polling unit]. In response to receiving a poll signal from a tag, the mobile terminal emits an audible signal and returns a found signal to the [currently] polling tag. The polling tag provides the user with a found/not-found indicator. Thus, individual tags can be used to locate the mobile terminal.”

U.S. Pat. No. 6,774,782 discusses a similar idea. “Preferably, the tags themselves include a poll switch that, when actuated by the user, allows an individual tag to poll the mobile terminal. In this manner, any tag may be used to assist the user in locating the mobile terminal.”

While the background art does recognize the problem of a portable polling unit becoming lost or stolen, their solutions to this problem have at least two shortcomings. One shortcoming is the need to have another unit which is able to poll. The second shortcoming is an inefficient means for notifying an owner of the polling unit about the unit's loss or theft. Regarding the first shortcoming, it is not always conceivable for there to be two polling units in a monitoring system. Regarding the second shortcoming, it is not always feasible for a user to be able to predict where he may be contacted—e.g. a certain landline phone. Therefore, relying on such an assumption is likely to lead to considerable delay in the user being notified about the loss or theft of a polling unit.

Therefore, these units are deficient when it is infeasible to have two or more polling units and/or in a scenario where a user is mobile and unable to always predict where he may be reachable. In such circumstances, the user may not be automatically informed in a short time period regarding a loss or theft of the polling unit.

### BRIEF SUMMARY OF THE INVENTION

In accordance with an aspect of the current invention, the limitations of the prior art are avoided by adapting a polled unit to automatically detect when it has not received a polling signal within a given time period, and to perform a function upon the detection of the absence of a polling signal. The absence of a polling signal at the polled unit for a given time period, is taken as an indication that the polling unit is out of polling range of the polled unit and therefore the polling unit is possibly lost or stolen. All of this is accomplished in this aspect of the current invention even though the polled unit does not possess its own polling means.

In accordance with an embodiment of the invention, the polled unit is adapted to perform the function of issuing a notification. In a feature of this embodiment, the issuing of a notification comprises broadcasting of an audio, visual, or vibrating alarm at the polled unit itself. In another feature of this embodiment, the issuing of a notification is a transmission to another unit, or to a service provider associated with the polling and/or polled unit.

In accordance with the embodiment in which the notification is a transmission to a service provider, there are several possible further features which involved actions which the service provider may perform. A first feature involves locating the polling unit, for example, with a global positioning system (GPS). A second feature involves transmitting an instruction for some other unit to broadcast an audio, visual, or vibrating alarm concerning the loss of the polling unit. A third feature involves interrupting the service provider's service to the missing polling unit. A fourth feature involves disabling the polling unit remotely.

In accordance with a further embodiment of the invention, the polling signal is a wireless signal, such as a radio frequency (RF) wireless signal. In a further embodiment, the polled unit is adapted to alter or modulate the received wireless signal and then to transmit the altered or modulated signal. The alteration or modulation is of such a character that the transmitted signal may be differentiated from a backscattered but otherwise unaltered signal. In a further embodiment that may be used with the latter embodiment, the polled unit utilizes the energy contained in the polling signal to power the transmission process. In this embodiment, the received wireless signal provides part or even all of the power needed for the polled unit to transmit a signal and, therefore, the polled unit does not require its own power source to fulfill this function.

In accordance with another embodiment of the invention, a distance over which a polled object is polled may be adjusted even after an initial setting. Some examples of parties who may adjust the distance setting include a user and a service provider.

In accordance with another embodiment of the invention, the given time period waited before the polled unit performs a function is adjustable. Some examples of parties who may adjust the given time period include a user and a party providing a service to the user.

These and other advantages of the invention will be apparent to those of ordinary skill in the art by reference to the following detailed description and the accompanying drawings.

### BRIEF DESCRIPTION OF THE DRAWINGS

FIG. 1 is a schematic representation of a polling unit.

FIG. 2 is a flowchart representing a process carried out utilizing a polling unit.

FIG. 3 is a schematic representation of a polled unit.

FIG. 4 is a flowchart representing a process carried out utilizing a polled unit.

### DETAILED DESCRIPTION

A common concern for a person carrying a small object is the possibility of at least one of these objects becoming lost or stolen. Various solutions have been proposed in the background art. One of the proposed solutions is to use a monitoring system comprising a polling unit that sends out a polling signal to a polled unit, the polled unit either being the monitored object or being attached to the monitored object. If the polled unit is within range of the polling unit, then the polled unit receives the polling signal and responds back to the polling unit. In the absence of any response from the polled unit, the polling unit may perform an operation—such as notifying an owner of a monitored object that the object may be lost or stolen. In one scenario, the polling unit is itself a portable object, such as a cellular phone or PDA. These portable make good polling units since they already have the necessary processor capabilities to be able to take on an additional role as a polling unit.

In the scenario where the polling unit itself is portable, a person utilizing this system is likely to also be concerned about monitoring this polling unit. However, this may be challenging since there may not be any other unit in the monitoring system capable of polling. If so, there is no unit available to monitor the polling unit.

There are some attempts in the background art to address this concern. Some examples of approaches include: a) using a second polling unit for detecting a loss of the first polling unit, b) detecting, by the user, a loss of the polling unit, and c) attaching a polled unit to one's person and programming the polling unit to notify an outside party or a landline telephone of the user when the polling unit can no longer communicate with this particular polled unit. There are at least two shortcomings of these approaches. One shortcoming is a need to have another polling unit in the system, which may not be technically or practically feasible. A second shortcoming is a potential delay in transmitting the information about the loss to the user in a quick and automated manner. This delay may occur either when an outside party is contacted or when the user's landline telephone is called. Since the user is mobile, it may be difficult to predict how to contact the user in order to provide information about the loss or theft of a polling unit.

Due to at least the above mentioned shortcomings, the background art falls short in providing a desirable way to avoid the shortcoming of a slow and/or manual approach to informing a user of a portable polling unit about the unit's loss or theft.

In accordance with an aspect of the current invention, the limitations of the prior art are avoided by adapting a polled unit to automatically detect when it has not received a polling signal within a given time period, and to perform a function upon the detection of the absence of a polling signal. The absence of a polling signal at the polled unit for a given time period, is taken as an indication that the polling unit is out of polling range of the polled unit and therefore the polling unit is possibly lost or stolen. All of this is accomplished in this aspect of the current invention even though the polled unit does not possess its own polling means.

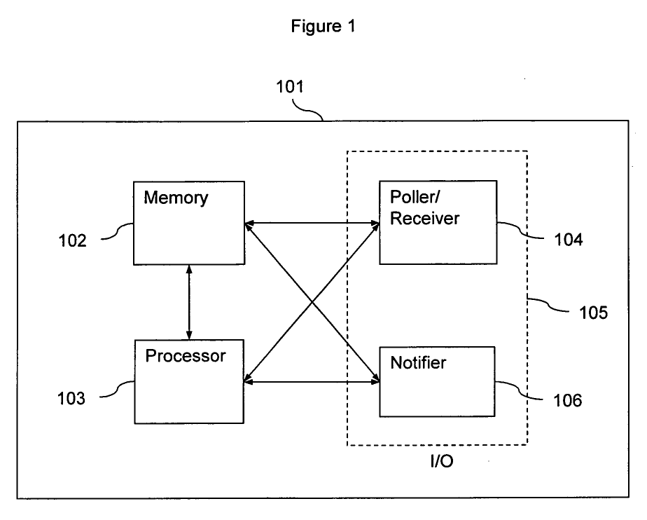

FIG. 1 is a schematic representation of an embodiment of a polling unit. This figure shows an interconnection between different parts of the polling unit, 101. A memory, 102, e.g., random access memory (RAM) and/or read only memory (ROM), is communicatively connected to a) a processor, 103, e.g., a CPU, b) a poller/receiver, 104, of the input/output block, 105, and c) the notifier, 106, of the input/output block, 105. The processor, in addition to being communicatively connected to the memory, is communicatively connected to both parts of the input/output block, i.e. the poller/receiver and the notifier, 106. In the input/output block, the poller/receiver is adapted to be able to transmit a polling signal as well as receive back a response from the polled unit.

The processor on the polling unit is adapted to detect whether the unit has received back some sort of response from a polled unit. If no response is received within a given time period, then the processor is adapted to activate the notifier to perform a function.

One example of a function performed by the notifier is broadcasting an alarm on the polling device itself. In this example, the notifier in the figure is the alarm. In another example, the function performed by the notifier is transmitting a notification to a third party that no response signal has been received from the polled unit. In this example, the notifier in the figure is a transmitter.

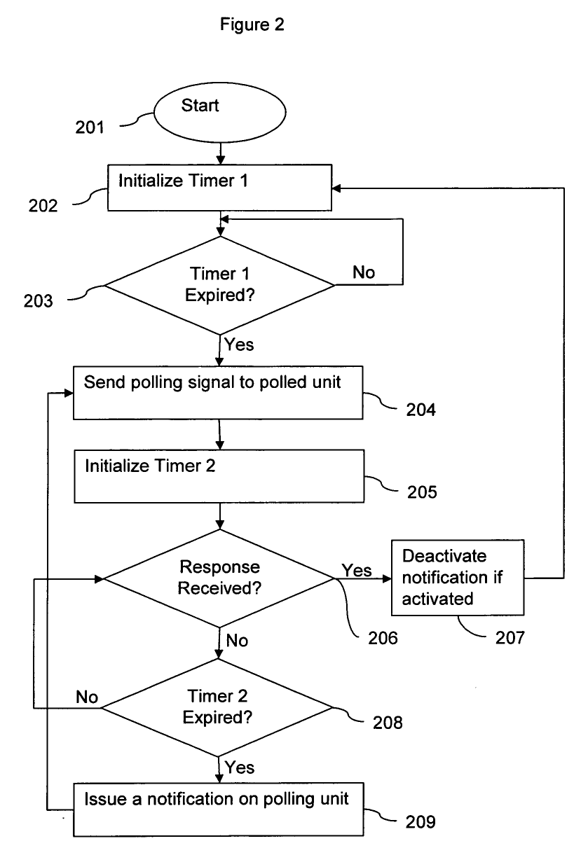

FIG. 2 is a flowchart representing a process carried out utilizing a polling unit. The process starts at step 201. At step 202, timer 1 is initialized. Timer 1 is the amount of time between polling cycles. At step 203, it is determined if timer 1 has expired. If it has not yet expired, then the process delays at step 203 until timer 1 expires. If it has expired, then a new polling cycle commences. At step 204, a polling signal is sent to a polled unit. This polling signal, in one embodiment, is a wireless signal. In one example of this embodiment, the polling signal is an RF wireless signal. At step 205, a second timer, timer 2, is initialized.

The process continues at step 206 where it is ascertained if a response has been received from the polled unit. If no response has been received, then at step 208, it is determined if timer 2 has expired. If it has not yet expired, then the process returns to step 206 until either timer 2 expires or the polling unit receives a response from the polled unit. If timer 2 expires before a response is received by the polling unit from the polled unit, then—at step 209—the polling unit is adapted to issue a notification. This notification may be a broadcasting of an aural, visual, or vibrating alarm located in the polling unit itself. Alternatively, the notification may be a transmission to another unit or to a service provider. In either case, the process continues by returning to step 204 where another polling signal is transmitted to the polled unit.

When a response is received from a polled unit, the process continues at step 207. If a notification has been issued, this step terminates the notification. Then, whether or not a notification has been issued—and subsequently terminated—the process continues at step 202 where timer 1 is reinitialized in order to run through another polling cycle.

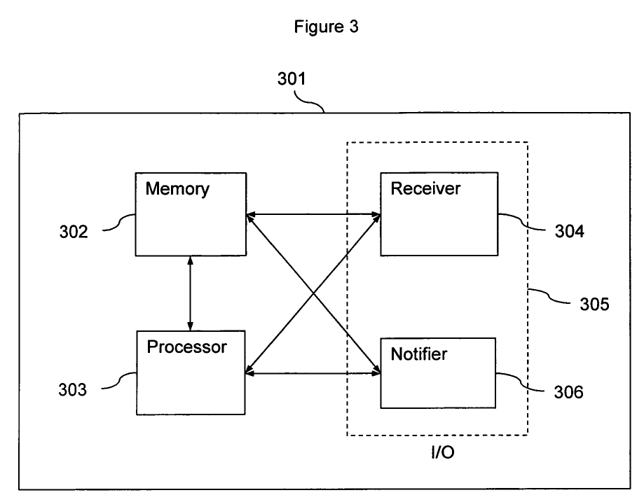

FIG. 3 is a schematic representation of an embodiment of the polled unit. This figure shows an interconnection between different parts of the polled unit, 301. A memory, 302, is communicatively connected to a) a processor, 303, b) a receiver, 304, of the input/output, 305, block, and c) the notifier, 306, of the input/output, 305, block.

The processor, in one embodiment, is a microprocessor. In another embodiment, the processor is an application-specific integrated circuit (ASIC). An ASIC is an integrated circuit (IC) customized for a particular use. This is in contrast to a microprocessor, which is intended for general-purpose use. The processor, in additional to being communicatively connected to the memory, is also communicatively connected to both parts of the input/output block, the receiver and the notifier, 306. In this embodiment, the polled unit has a notifier. However, in a separate embodiment, the input/output block only contains a receiver without containing a notifier.

In accordance with the embodiment illustrated in FIG. 3, the polled unit is adapted to perform the function of issuing a notification. In a feature of this embodiment, the issuing of a notification is a broadcasting of an aural, visual, and/or vibrating alarm on the polled unit itself. In this embodiment, the notifier in the input/output block is a means broadcasting the aural, visual, and/or vibrating alarm. Some examples of these alarms include an alerting feature based on sound such as a beeper or siren, based on sight such as flashing lights, based on vibration, and any combination of these features.

In another feature of this embodiment, the issuing of a notification is a transmission to another unit or to a service provider. In regards to transmitting to a service provider, there are several possible further features concerning actions which may be performed. A first feature involves the locating of the polling unit, for example, with a global positioning system (GPS). A second feature involves transmitting an instruction for some other unit to broadcast an aural, visual, or vibrating alarm concerning the loss of the polling unit. A third feature involves interrupting the service provider's service to the missing polling unit. A fourth feature involves disabling the polling unit remotely. Other actions which may be performed by a service provider may be envisioned by those of ordinary skill in the art.

A fundamental difference between the polling unit and the polled unit regards the polling signal. The polling unit has poller, see 104 in FIG. 1, for transmitting a polling signal—such as an RF wireless signal—to a polled unit. However, the polled unit does not have a means for transmitting a polling signal.

In another embodiment, the polled unit is adapted to alter or modulate the received wireless signal and then to transmit the altered or modulated signal. The alteration or modulation is of such a character that the transmitted signal may be differentiated from a backscattered but otherwise unaltered signal. By responding to the polling signal—whether by transmitting back the very same signal or by first altering or modulating the signal—the polled unit indicates that it is within a given distance of the polling unit.

In a further embodiment that may be used with receiving a wireless transmission, the polled unit utilizes the energy contained in the polled signal to power transmission process. In this embodiment, the received wireless signal provides part or even all of the power needed for the polled unit to transmit a signal and, therefore, the polled unit does not require its own power source to fulfill this function.

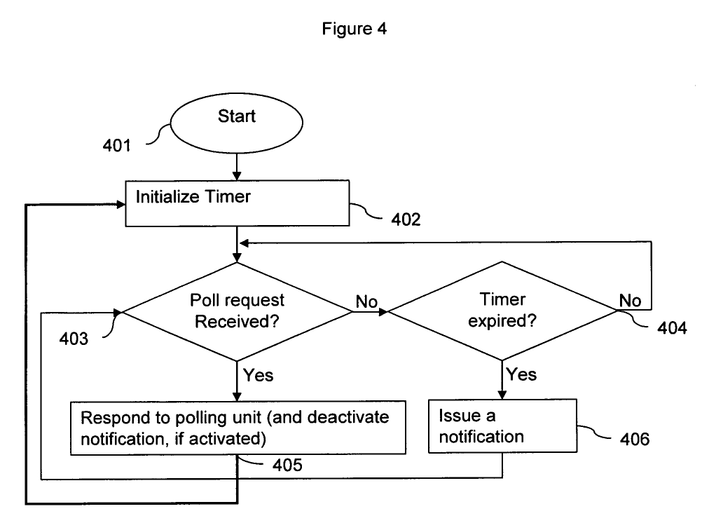

FIG. 4 is a flowchart representing a process carried out utilizing a polled unit. The process starts at step 401. At step 402, a timer is initialized. The timer counts the amount of time since a previous polling signal was received from a polling unit. At step 403, it is determined if a polling signal has been received.

If no polling signal has been received, the process continues at step 404 to determine if the timer has expired. If it has not yet expired, then the process continues back at step 403 until either the timer expires or a polling signal is received. If the timer expires before a polling signal is received, then the polled unit issues a notification, at step 406. The process then continues back at step 403 to see if a polling signal has been received.

However, if a polling signal has been received, then a response is made by the polled unit to the polling unit at step 405. In one embodiment, where the polling signal is a wireless signal, a wireless transmission is retransmitted back to the polling unit. In a further embodiment, if the polling signal is an RF wireless signal, an RF wireless signal is transmitted back to the polling unit. In a further embodiment, the polled unit alters or modulates the received wireless signal. The polled unit then transmits the now altered or modulated wireless signal back to the polling unit. This indicates to the polling unit that the polled unit is within polling range. As discussed previously, in one embodiment, the polled unit utilizes the energy contained in the polling signal to carry out this alteration or modulation and to transmit a wireless signal back to the polling unit. Regardless of what signal is transmitted back to the polling unit, the polled unit deactivates any notification that has been previously issued, and then continues back at step 402 where the timer is reinitialized.

The polling system can be made more or less sensitive to loss or theft detection in at least a few different ways. One way to make the polling system more sensitive is to reduce a distance of coverage of a polling signal transmitted by a polling unit. By doing this, less distance between the polling unit and polled unit is needed in order to fall out of range of one another. Therefore, with all other factors being equal, the smaller the distance, the more sensitive the polling setup is to an object being lost or stolen. The larger the distance, the less sensitive is the setup.

However, a downside to making the distance smaller is that this change may lead to more false positives. False positives in this context mean that the polling setup will give an erroneous reading that an object is lost or stolen when really it is still on the premises, but it just fell outside of the polling distance.

In accordance with one embodiment of the invention, a distance of coverage of a polling signal transmitted from a polling unit is fixed at a time of manufacturing. In another embodiment, it is fixed at some later time after the polling unit's manufacture, for example, by a user or a party providing a service to a user. In yet another embodiment, a distance of coverage of a polling signal transmitted from a polling unit may be adjusted even after an initial setting. Some examples of parties who may adjust the distance setting include a user and a party providing a service to the user.

Another way to make the polling system more sensitive is to reduce the time period which is allowed for a polled unit to respond to a polling signal from a polling unit. The longer the time period, the longer it could potentially take to determine that an object has fallen out of polling range. Therefore, it would seem that this time should be minimized in order to make the polling setup as sensitive as possible.

One limiting factor on how short this time can be is based on the polling unit's polling protocol. This time period discussed above must be longer than the length of each cycle of transmitting a polling signal by the polling unit, i.e. timer 1 in FIG. 2. If this is not the case, then even an object still within the polling distance will, at times, issue a notification that it is out of range of the polling unit because the time period wasn't long enough to allow the polling unit to send out a polling signal.

In accordance with one embodiment of the invention, the given time period waited before the polled unit performs a function, such as issuing a notification, is fixed. Parties that may fix this value are the manufacturer of the polled unit, a user, and a party providing a service to the user In accordance with another embodiment of the invention, the given time period waited before the polled unit performs a function is adjustable. Some examples of parties who may adjust the given time period include a user and a party providing a service to the user.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A system comprising:
a first unit adapted to a) transmit a polling signal, over a given distance, to a second unit, and b) receive back an indication from the second unit that the second unit received the said polling signal; and,
the second unit adapted to a) detect whether it has received the said polling signal within a given time period, and b) perform a function upon failure to receive the said polling signal within the said time period.

2. The system of claim 1, wherein:
the second unit is adapted to issue a notification upon failure to receive the said polling signal within the said time period.

3. The system of claim 2, wherein:
the second unit is adapted to broadcast an alarm if the said notification is issued.

4. The system of claim 2, wherein:
the second unit is adapted to send a transmission to at least one other unit if the said notification is issued.

5. The system of claim 1, wherein:
the first unit is adapted to transmit the polling signal as a wireless signal.

6. The system of claim 5, wherein:
the first unit is adapted to transmit a wireless signal as a radio frequency (RF) wireless signal.

7. The system of claim 5, wherein:
the second unit is adapted to alter the polling signal and to transmit the altered polling signal.

8. The system of claim 7, wherein:
the second unit is adapted to use energy from the polling signal to transmit the altered polling signal.

9. The system of claim 1, wherein:
said given distance may be adjusted, even after an initial setting.

10. The system of claim 1, wherein:
said given time period may be adjusted, even after an initial setting.

11. An apparatus comprising:
a processor;
a memory, said memory communicatively connected to the processor;
an input/output, said input/output communicatively connected to the processor and to the memory,
said input and output comprising of a receiver; and,
said processor adapted to a) detect whether the apparatus has received a polling signal in a given time period, and b) perform a function upon failure of the apparatus to receive the said polling signal within the given time period.

12. The apparatus of claim 11, wherein:
said apparatus adapted to a) receive the polling signal, said polling signal comprising a radio frequency (RF) wireless signal, and b) return a response signal, said response signal comprising an RF wireless signal.

13. The apparatus of claim 11, wherein:
said processor being an application-specific integrated circuit (ASIC).

14. The apparatus of claim 11, wherein said input/output further comprises:
a notifier, said notifier comprising an alarm.

15. The apparatus of claim 14, further comprising:
said processor adapted to perform a function of activating the alarm in the absence of a detected polling signal in the given time period.

16. The apparatus of claim 11, wherein said input/output further comprises:
a notifier, said notifier comprising a transmitter.

17. The apparatus of claim 16, further comprising:
said processor adapted to perform a function of transmitting an alert in the absence of a detected polling signal in the given time period.

18. A method comprising:
receiving a notification from a polled unit,
said polled unit adapted to receive a polling signal from a polling unit; and,
said notification indicating a failure to receive the said polling signal by the polled unit within a given time period.

19. The method of claim 18, further comprising:
determining a location of the polling unit.

20. The method of claim 18, further comprising:
causing the polling unit to broadcast an alarm.

21. The method of claim 18, further comprising:
terminating a service for the polling unit.

22. The method of claim 18, further comprising:
disabling, remotely, the polling unit.
